(19) United States
(12) Patent Application Publication
(10) Pub. No.: US 2009/0178814 A1
(43) Pub. Date: Jul. 16, 2009

(54) METHOD FOR EXTINGUISHING A SMOULDERING FIRE IN A SILO

(76) Inventors: Michael HEISEL, (US); Ron Clark Lee, (US)

Correspondence Address: The BOC Group, Inc., 575 MOUNTAIN AVENUE, MURRAY HILL, NJ, 07974-2082, US

(21) Appl. No.: 11/953,934

(22) Filed: Jan. 11, 2008

(51) Int. Cl. A62C 3/04; A62C 31/02; E04H 7/22

(52) U.S. Cl. 169/46; 169/70; 52/192

(57) ABSTRACT

The invention relates to a method for extinguishing a smouldering fire in a silo by introducing inert gas into the silo. The inert gas is introduced through a venturi-type nozzle above the stored content in the silo with a slow streaming velocity in such a way that mass ratio of the entrained surrounding gas to the incoming liquid inert gas is between 0.5 and 20. Thus a closed inert gas layer is formed above the smouldering fire.

### BACKGROUND OF THE INVENTION

The invention relates to a method for extinguishing a smouldering fire in a silo by introducing inert gas into the silo. The invention further relates to a silo for storing deposited goods having at least one inlet for inert gas.

It is not uncommon for silos with biomass to have fires and in particular smouldering fires. Biomass always contains highly combustible components. In addition, the fermentation of biomass produces heat and biogas. The heat itself may be sufficient to start a fire. Biogas makes matters even more dangerous since it substantially comprises carbon dioxide, water and the highly combustible gas methane. Said biogas has a high heating value. A different source of ignition may be materials which collect electric charge for instance synthetic materials are charged electrostatically by friction and may ignite the biogas through electric discharge and thus form the starting point of a fire in the stored material.

The void space in the biomass in the silo contains air and thereby provides the oxygen necessary for the fire. However the biomass is normally densely stored or compressed so that circulation of air in the biomass is very limited. This restricted circulation leads to a sub-stoichiometric or smouldering fire in contrast to an open fire with a surplus of air available. For example, if a fire starts inside the biomass due to the above mentioned mechanisms the oxygen in the void spaces will be consumed first. Because of the limited air circulation in the biomass the amount of oxygen necessary for an open fire is not provided.

In this application the term “smouldering fire” is understood as an incomplete combustion with a sub-stoichiometric oxygen supply. In a smouldering fire a large amount of hydrogen and carbon monoxide is produced. Both gases are lighter than air and thus rise into the empty headroom above the stored biomass, where they can form explosive mixtures with the air contained there.

Fires in biomass silos or biomass bunkers are particularly dangerous because biomass represents a mixture of different materials. This leads to an increased formation of hydrogen near the site of fire itself. In the sub-stoichiometric combustion present in a smouldering fire the site of fire itself produces hydrogen, carbon monoxide and reduces metals which could in turn become catalytically effective. Hydrogen as a small and light molecule diffuses quickly through the biomass and collects in the headroom of the biomass bunker and can lead to detonating gas reactions together with the aerial oxygen.

Therefore, the danger of explosion in the headroom is not lowered by fire fighting with water. Furthermore, water often does not reach the site of the fire since it is absorbed by the biomass and does not flow further into the biomass. Thereby the weight of the biomass can increase such that the silo or bunker could be destroyed mechanically. Additionally many deposited goods form hard layers with the addition of water such that emptying the silo or bunker after or during the fire fighting is more complicated or becomes even impossible. Therefore water should be only employed as an extinguishing agent in fires at or near the surface of the deposited goods.

Various methods for extinguishing a fire without using water have been suggested before. From EP-0133999 an apparatus for fighting seats of fire inside stored materials is known for supplying the site of the fire with pressurised extinguishing agent by means of a lance. U.S. Pat. No. 2,006,258 describes a device for blowing an extinguishing gas into a powdery material stored in a container.

In U.S. Pat. No. 6,199,493 it is proposed to introduce an inert gas from below into the silo when storing waste in a silo, such that the inert gas, particularly nitrogen or carbon dioxide, flows through the waste and can be extracted at the upper end of the silo. Thus, the entire inside of the silo is to be inerted. This method is not favourable for biomass containing silos in small agricultural farms because of the costs and the danger for the people who have to deal regularly with the stored biomass.

Preferably fires in goods are extinguished with inert gas. When flooding a silo with inert gas the air in the goods is displaced into the headroom. However, the displaced air flowing through the goods may initially temporarily fan the fire before it is suffocated by the inert gas. This temporary increase in combustion may lead to further seats of fire and smouldering fires and generate sparks which by themselves increase the risk of explosions in the headroom. Further the supplied inert gas may raise dust and thereby drastically increasing the risk of dust explosions.

In a co-pending U.S. application (application Ser. No. 11/879,911) of the Applicants a method for extinguishing a fire in a silo by introducing an inert gas and extracting the waste gas above the stored burning content is described. Explosions in silos have so far for the most part been interpreted as explosions of biogas or dust explosions. Research has now shown that a bigger danger comes from hydrogen, which is produced by the smouldering fire of the biomass in the silo as mentioned above. As a small molecule, hydrogen can diffuse particularly well through the biomass or the deposited goods and collect in the headroom of the silo. There, the hydrogen can react easily with the existing air. The object of the former application is to minimize the risk of explosion by extinguishing the smouldering fire by the introduction of inert gas and extraction of the hydrogen containing waste gas from above the deposited goods at the same time.

New results exhibit an increasing risk of explosion by turbulences in the atmosphere of the headroom resulting from the simultaneous gas introduction and extraction.

### BRIEF SUMMARY OF THE INVENTION

Therefore, it is an object of the invention to show a method for fighting fires in silos which avoids the above mentioned disadvantages and especially minimizes the risk of explosions.

This object is achieved by a method of the above type, whereby the inert gas is injected as liquid gas through at least one venturi-type nozzle above the stored content in the silo with a slow streaming velocity in such a way that mass ratio of the entrained surrounding gas to the incoming liquid inert gas is between 0.5 and 20.

Within the frame of this description the term “silo” is understood as a substantially closed storage container for deposited goods, for example bulk goods from biomass, e.g., corn, animal feed, and wood pellets or also waste or cement. The silo may be of a tower-like, often cylindrical design.

The method according to the invention exhibits a variety of advantages. The venturi-type nozzle uses the motive capability of the high pressure liquid inert gas to entrain the surrounding gas in the silo. The controlled mass ratio together with the slow streaming velocity according to the invention ensures the liquid gas is fully vaporised while the entrained gas is cooled. Thereby the maximum cooling power of the liquid inert gas is deposed in the interior of the silo and thus heat is extracted from the site of the fire. It is advantageous to limit the amount of entrained surrounding gas to the minimum necessary to fully vaporise the liquid inert gas by the slow streaming velocity and the controlled mass ratio. In this fashion the amount of mixed gas exiting the venturi-type nozzle is minimised and the gas is relatively cool. In this way the low velocity is generated in the cold, dense gas. If the inert gas is injected with a slow streaming velocity according to the invention it spreads over the surface of the deposited goods and forms a closed layer of inert gas. Surprisingly such layers are rather stable in time as shown in experiments. This layer could be achieved by injection through a venturi-type nozzle which is formed in such a way that the inert gas is released with a slow streaming velocity from the venturi-type nozzle.

Preferably the mass ratio of the entrained surrounding gas to the incoming liquid inert gas is between 1.0 and 5.0.

In a preferred embodiment of the invention carbon dioxide is used as inert gas. Using carbon dioxide as an inert gas has the advantage of collecting in the lower part of the silo because it is heavier than air. In the case of a fire in the silo the uplift due to the convection through hot flames and gravity act against each other such that carbon dioxide remains at the site of the fire and suffocates the fire.

Smouldering fires generate hydrogen and carbon monoxide which are inflammable gases. They rise to the headroom of the silo because of their light weight and/or the convection which is induced by the heat of the fire. These gases may explode by contact with air and a spark. It is therefore mandatory to avoid any sparks from reaching the headroom of the silo. Surprisingly a layer of inert gas especially carbon dioxide formed according to the invention is a very efficient means to extinguish sparks. It is a lot more efficient than e.g., nitrogen or air. Therefore a layer of carbon dioxide is able to prevent one of the most dangerous effects, explosions or deflagrations, by preventing sparks reaching the headroom of the silo with accumulated explosive gas mixtures of hydrogen, carbon monoxide and air. Therefore the present invention is a sufficient means to minimise the risk of explosions in silos.

The smouldering fire consumes air as long as it continues smouldering. At the same time gases generated by the fire (hydrogen and carbon monoxide) leave the site of the fire. Both effects lead to more air from the surrounding being sucked into the site of the fire. If the lower part of the silo is essentially gastight carbon dioxide from the carbon dioxide layer is the only spare gas available to replace the air consumed by the fire after some time smouldering. Carbon dioxide is a very heavy gas in comparison to air and thus it will not rise easily from the site of the fire. A small percentage of the carbon dioxide (approximately 1-3%) will break up to form carbon and carbon dioxide and continue to react according to the Boudouards reaction to soot and carbon monoxide. But this effect is not sufficient enough to increase the combustion. Therefore the main effect of the formed inert gas layer according to the invention is the cut off the fire from free oxygen and therefore the decrease of the combustion.

Another effect of the inert gas layer is the separation of the smoke generated by the fire and the surrounding atmosphere. It was found that the inert gas layer is formed between the smoke generated by the smouldering fire and the surrounding gas. The inert gas layer itself remains essentially free of smoke and thus allowing a clear view into the silo for inspection of the site of the fire and thereby the directed application of secondary fire fighting methods.

Preferably the streaming velocity of the inert gas is between 0.1 m/s and 10 m/s, more preferably between 0.2 m/s and 1.0 m/s. The use of a venturi-type nozzle ensures the full vaporisation of the liquid inert gas. If carbon dioxide is used as inert gas it is important to ensure the full vaporisation of the inert gas. Research showed that a layer of carbon dioxide can very efficiently catch all sparks and thus reduce the risk of explosion substantially. In order to form such a layer the carbon dioxide has to be introduced by a venturi-type nozzle at low velocity. This leads to minimal turbulence or mixing results. On the other hand the velocity must not to be too low because then the carbon dioxide does not spread well over the whole surface of the material stored. The preferred velocity in the range of 0.1 m/s to 10 m/s and more preferably between 0.2 m/s and 1.0 m/s is the most efficient way to form such a layer. At higher gas velocities turbulence occurs and air mixes into the carbon dioxide layer. The result is that sparks reaching this level remain a lot longer glowing and the risk of an explosion being ignited by such spark rises dramatically. The injection of the liquid inert gas through a venturi-type nozzle together with the slow streaming velocity of the inert gas according to the present invention eliminates the risk of sparks formation.

Advantageously the inert gas is injected in an essentially horizontal manner. The injection in an essentially horizontal manner ensures the formation of a flat and broad inert gas layer.

According to a particular embodiment of the invention the inert gas is injected through more than one venturi-type nozzles, wherein the venturi-type nozzles are distributed over the whole circumference of the silo in the same plane, whereby the overlap of the output of the venturi-type nozzles is minimised. This embodiment of the invention is of particular interest for silos with a larger diameter, e.g., 3 m or bigger. The injection of inert gas through several venturi-type nozzles distributed over the whole circumference of the silo to generate a large and essentially closed inert gas layer over the whole surface of the deposited goods. The overlap of the output areas of the venturi-type nozzles is minimised to minimise the turbulence in the atmosphere in the silo. A great overlap of the output would lead to an increased turbulence in the atmosphere because of gases streaming in the opposite direction. This turbulence would prevent the formation of a stable inert gas layer and increase the risk of explosion by sparks. Additionally turbulence would lead to a mixing of air into the liquid inert gas layer. This results in a longer glowing of the sparks and thereby to an increased risk of an explosion being ignited by sparks.

According to another particular embodiment of the invention the inert gas is injected through more than one venturi-type nozzles, wherein the venturi-type nozzles are distributed over the height of the silo, preferred with a distance between 3 m and 5 m between each other. This embodiment of the invention is of particular interest for silos with a larger height. The filling level differs from time to time especially in silos with a smaller diameter and a larger height. This embodiment of the invention ensures the injection of the inert gas close to the surface of the deposited goods independent of the filling level.

The invention also relates to a silo for storing deposited goods having at least one inlet for inert gas. According to the invention the inlet for inert gas is formed as a venturi-type nozzle comprising an inlet nozzle for the inert gas, openings for introduction of atmospheric gas, a mixing throat and a diffuser, wherein the diffuser is essentially flat and the venturi-type nozzle is in an essentially horizontal orientation. A venturi-type nozzle is a suitable means to introduce an inert gas with a slow streaming velocity and a controlled mass ratio into a silo to establish an essentially flat horizontal inert gas layer.

The mixing throat exhibits preferably a cross section which is essentially circular, the length of the mixing throat is preferably between the twofold and the fivefold of the diameter of the mixing throat and the length of the diffuser is preferably between the threefold and tenfold of the diameter of the mixing throat. Advantageously the opening angle of the diffuser is between 10 degrees and 30 degrees. The ratio of the square of the diameter of the mixing throat to the square of the diameter of the opening of the inlet nozzle for the inert gas is preferably between 10 and 1000, particularly favourable between 50 and 400.

The liquid inert gas is introduced through a conventional injection nozzle in the mixing throat of the venturi device. The conventional injection nozzle is preferably configured to produce as straight of a liquid as possible. The diameter of this nozzle is selected according to standard practice to produce the desired liquid inert gas flow rate. The substantially circular mixing throat is of a diameter such that the ratio of the square of the diameter of the mixing throat to the square of the diameter of the opening of the injection nozzle is preferably in the range of 5 to 100, particularly favourable in the range of 50 to 100. Preferably the injection nozzle is placed at a distance from the mixing throat equivalent to 0 to 2 times the diameter of the mixing throat. The mixing throat length is preferably in the range of 3 to 20 times the diameter of the mixing throat in length, and particularly favourable has a smoothly tapering inlet. The gaseous atmosphere is introduced through openings in the sides and/or ends upstream of the injection nozzle. The amount of entrained atmosphere gas relative to the incoming liquid inert gas is generally controlled by the incoming liquid inert gas pressure, the ratio of the diameters of the injection nozzle and the mixing throat and by the size of the atmosphere openings. Preferably the amount of entrained atmospheric gas is adjusted by the size of the atmospheric gas openings.

The exit region of the venturi-type nozzle is a diffuser section constructed to produce the desired low velocity cold discharge gas. The discharge section is designed to produce a relatively flat dispersion of gas, preferably through a diffuser having a rectangular or oblong cross section. In order to prevent flow separation in the diffuser, the diffuser angle is preferably within the range of 10 to 30 degrees, and may particularly favourably contain guide vanes to promote uniform diffusion. A diffuser plate is preferably placed at the discharge to further minimise large scale mixing vortices, and improve the uniformity of the discharge flow.

According to a particular embodiment of the invention more than one venturi-type nozzles are distributed over the circumference of the silo and the opening of the diffusers are not oriented opposite to each other. This embodiment of the invention is of particular interest for silos with a larger diameter. More than one venturi-type nozzles for the injection of inert gas are distributed over the whole circumference of the silo to generate a large and essentially closed inert gas layer over the whole surface of the deposited goods. The openings of the diffuser of the venturi-type nozzle are oriented in a not opposite direction and thereby the overlap of the resulting gas streams is minimised. Particularly favourable the venturi-type nozzles are oriented in such that they are pointing either tangentially or in an acute angle from the silo wall. Thus the gas moves in a slow circular rotation filling the silo and forming a gas layer in the process.

According to another particular embodiment of the invention more than one venturi-type nozzles are distributed over the height of the silo, preferred with a distance between 3 m and 5 m between each other. In this embodiment of the invention the inert gas is injected through the venturi-type nozzles which are in the closest distance above the surface of the deposited goods.

Preferably means for the supply of the liquid inert gas for the venturi-type nozzle are located in a safe distance from the silo. The installation of means, e.g., pipes, for supplying the inert gas to the venturi-type nozzle from a safe distance allows the fire fighting from a safe distance. No person has to climb up the burning silo to spray water on top, open inlet or outlet gates to remove the stored goods. This is a substantial increase in safety for the fire fighting personnel.

The present invention has several advantages over the prior art. The main advantage is the minimisation of the risk of explosions. The risk of an explosion is drastically lowered through the elimination of the risk of sparks by the inert gas layer. The fire fighting from a safe distance is possible. Due to the lowered risk of explosions the risk of damage to persons or the silo is lowered. Also there is no water damage in the silo and the material stored in the silo could be re-used. Thus the insurance costs are lowered due to much lower damages from smouldering fires.

The invention will be described in more detail hereinafter by some embodiment of the invention shown in the figures.

### BRIEF DESCRIPTION OF THE DRAWINGS

FIG. 1 shows an inert gas layer formed by one venturi-type nozzle in a silo.

FIG. 2 shows three inert gas layers formed in a silo with a large diameter.

FIG. 3 shows one embodiment of the venturi-type nozzle according to the invention.

### DETAILED DESCRIPTION OF THE INVENTION

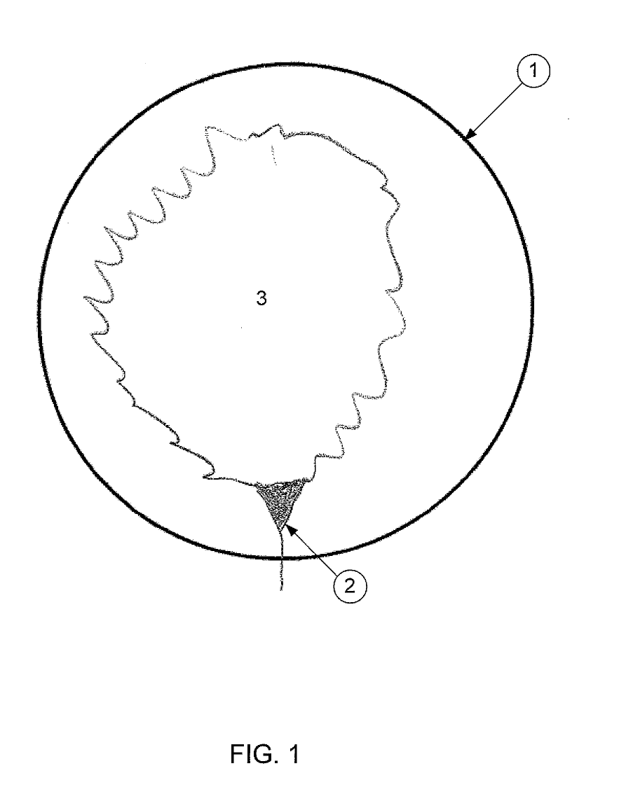

FIG. 1 shows an inert gas layer 3 formed by one venturi-type nozzle 2 in a silo 1 with a small diameter, e.g., with a diameter less than 3 m. The inert gas is injected as liquid gas through one venturi-type nozzle 2 above the stored content in the silo with a slow streaming velocity in such a way that mass ration of the entrained surrounding gas to the incoming liquid inert gas is between 0.5 and 20, preferably in the range 1.0 and 5.0. The venturi-type nozzle 2 is essentially horizontal oriented. Thereby an essentially horizontal flat inert gas layer 3 is formed above the smouldering fire.

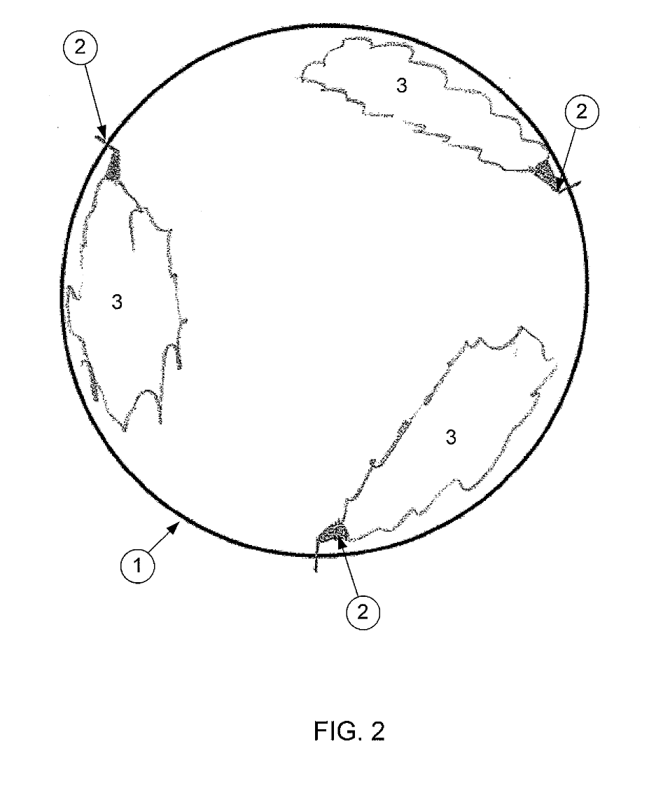

FIG. 2 shows one embodiment of the invention in a silo 1 with a larger diameter, e.g., more than 3 m. The inert gas is injected through three venturi-type nozzle 2 oriented in acute angle form the silo wall. Thereby no overlap of the resulting inert gas clouds 3 occurs. The formation of turbulence and air mixing into the inert gas layer is avoided and thereby a closed inert gas layer is formed.

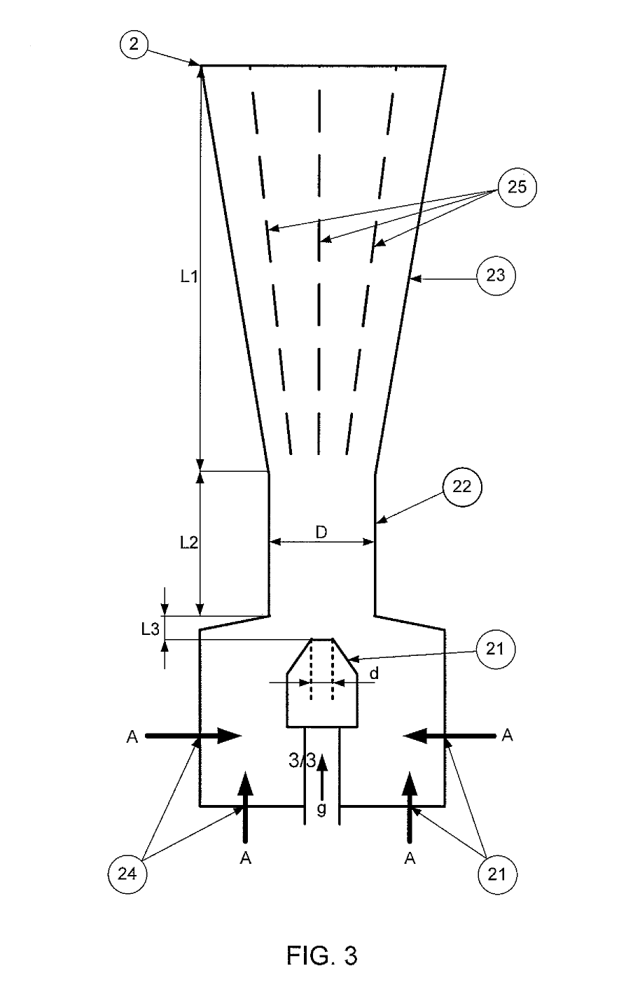

FIG. 3 shows one embodiment of a venturi-type nozzle 2 according to the invention in a schematic side view in more detail. The liquid inert gas g is injected through the inlet nozzle 21 and mixed with surrounding atmosphere A in the mixing throat 22. The surrounding atmosphere A enters the venturi-type nozzle 2 through side and end openings 24. The diameter d of the opening of the inlet nozzle 21 is designed to provide the desired liquid inert gas flow rate. The substantially circular mixing throat 22 is of a diameter D such that the ratio (D/d)̂2 is in the range of 50 to 100. The injection nozzle 21 is placed at a distance L3 from the mixing throat 22 equivalent to 0 to 2 times of the diameter D of the mixing throat 22. The mixing throat 22 has a length L2 that is in the range of 3 to 20 times the diameter D and has a smoothly tapering inlet. The diffuser 23 is constructed to produce the desired low velocity cold discharge gas. The diffuser 23 has a rectangular or oblong cross section to produce a relatively flat dispersion of gas. The opening angle of the diffuser 23 is in the range of 10 to 30 degrees. The diffuser 23 contains guide vans 25 to promote a uniform diffusion. The length L1 of the diffuser is in the range of 3 to 20 times the diameter D of the mixing throat 22.

What we claim is:

1. A method for extinguishing a smouldering fire in a silo by introducing inert gas into the silo, characterised in that the inert gas is injected as liquid gas through at least one venturi-type nozzle above the stored content in the silo with a slow streaming velocity in such a way that mass ratio of the entrained surrounding gas to the incoming liquid inert gas is between 0.5 and 20.

2. The method according to claim 1, characterised in that the mass ratio of the entrained surrounding gas to the incoming liquid inert gas is between 1.0 and 5.0.

3. The method according to claim 1, characterised in that carbon dioxide is used as said inert gas.

4. The method according to claim 1, characterised in that the streaming velocity of the inert gas is between 0.1 m/s and 10 m/s, preferably between 0.2 m/s and 1.0 m/s.

5. The method according to claim 1, characterised in that the inert gas is injected in an essentially horizontal manner.

6. The method according to claim 1, characterised in that the inert gas is injected through more than one venturi-type nozzle, wherein the venturi-type nozzles are distributed over the whole circumference of the silo in the same plane, whereby the overlap of the output of the venturi-type nozzles is minimised.

7. The method according to claim 1, characterised in that the inert gas is injected through more than one venturi-type nozzle, wherein the venturi-type nozzles are distributed over the height of the silo, preferred with a distance between 3 m and 5 m between each other.

8. A Silo for storing deposited goods having at least one inlet for inert gas, characterised in that the inlet for inert gas is formed as a venturi-type nozzle comprising an inlet nozzle for the inert gas, openings for introduction of atmospheric gas, a mixing throat and a diffuser, wherein the diffuser is essentially flat and the venturi-type nozzle is in an essentially horizontal orientation.

9. The silo according to claim 8, characterised in that the cross section of the mixing throat is essentially circular, the length of the mixing throat is between the twofold and the fivefold of the diameter of the mixing throat and the length of the diffuser is between the threefold and twentyfold of the diameter of the mixing throat.

10. The silo according to claim 8, characterised in that the opening angle of the diffuser is between 10 degree and 30 degree.

11. The silo according to claim 8, characterised in that the diffuser comprises at least one guide vane and/or a discharge diffuser plate.

12. The silo according to claim 8, characterised in that the ratio of the square of the diameter of the mixing throat to the square of the diameter of the opening of the inlet nozzle for the inert gas is between 10 and 1000.

13. The silo according to claim 8, characterised in that the ratio of the square of the diameter of the mixing throat to the square of the diameter of the opening of the inlet nozzle for the inert gas is between 50 and 400.

14. The silo according to claim 8, characterised in that more than one venturi-type nozzles are distributed over the circumference of the silo and the opening of the diffusers are not oriented in the opposite direction of each other.

15. The silo according to claim 14, characterised in that the venturi-type nozzles are oriented such that they are pointing either tangentially or in an acute angle from the silo wall.

16. The silo according to claim 8, characterised in that more than one venturi-type nozzles are distributed over the height of the silo, preferred with a distance between 3 m and 5 m between each other.

17. The silo according to claim 8, characterised in that means for the supply of the liquid inert gas for the venturi-type nozzle are located in a safe distance from the silo.
